(19) United States
(12) Patent Application Publication
(10) Pub. No.: US 2024/0281019 A1
(43) Pub. Date: Aug. 22, 2024

(54) MEASUREMENT CIRCUIT, MEASUREMENT INSTRUMENT, AND VECTOR NETWORK ANALYZER

(71) Applicant: Rohde & Schwarz GmbH & Co. KG, Munich (DE)

(72) Inventors: Florian Galler, Munich (DE); Julius Seeger, Munich (DE)

(73) Assignee: Rohde & Schwarz GmbH & Co. KG, Munich (DE)

(21) Appl. No.: 18/170,100

(22) Filed: Feb. 16, 2023

(51) Int. Cl. G06F 1/02; G06F 1/03; G06F 1/08

(52) U.S. Cl. CPC G06F 1/022; G06F 1/0328; G06F 1/08

(57) ABSTRACT

The measurement circuit includes a clock input, a frequency converter circuit, and a first signal generator circuit. The clock input is configured to receive a reference clock signal. The first signal generator circuit includes a first clock generator circuit configured to generate a first clock signal having an adaptable frequency based on the reference clock signal. The first signal generator circuit further includes a first direct digital synthesizer (DDS) circuit configured to generate a local oscillator (LO) signal based on the first clock signal and based on an adaptable frequency tuning word (FTW) of the first DDS circuit. The adaptable frequency of the first clock signal and the adaptable FTW of the first DDS circuit are configured such that an IF signal is free of spurs emitted by the first DDS circuit at least in a predetermined frequency band.

### FIELD OF THE DISCLOSURE

Embodiments of the present disclosure generally relate to a measurement circuit. Embodiments of the present disclosure further relate to a measurement instrument and to a vector network analyzer.

### BACKGROUND

In modern measurement instruments, direct digital synthesizers are employed in order to generate a local oscillator signal that is used for down-converting the frequency of a measured signal.

As is well known, direct digital synthesizers emit spurs depending on a frequency of a reference clock signal used by the direct digital synthesizer in order to generate the local oscillator signal.

If these spurs mix into the intermediate frequency (IF) range employed by the measurement instrument in order to perform measurements, the measurement results may be negatively affected. For example, the dynamic may be lost and the trace noise may increase by orders of magnitude.

In order to avoid the negative effects of the spurs on the measurement results, it is known to shift the IF of the measurement instrument. However, this approach is limited by the maximum possible IF of the measurement instrument.

Moreover, shifting the IF requires that the measurements are interrupted, such that the time necessary for performing the measurements is increased.

Thus, there is a need for a measurement circuit, for a measurement instrument, and for a vector network analyzer that allow for avoiding the negative effects of spurs emitted by a direct digital synthesizer in a more efficient manner.

### SUMMARY

Embodiments of the present disclosure provide a measurement circuit. In an embodiment, the measurement circuit comprises a clock input, a frequency converter circuit, and a first signal generator circuit. The clock input is configured to receive a reference clock signal. The first signal generator circuit comprises a first clock generator circuit that is connected to the clock input. The first clock generator circuit is configured to generate a first clock signal having an adaptable frequency based on the reference clock signal. The first signal generator circuit further comprises a first direct digital synthesizer (DDS) circuit that is connected to the first clock generator circuit. The first DDS circuit is configured to generate a local oscillator (LO) signal based on the first clock signal and based on an adaptable frequency tuning word (FTW) of the first DDS circuit. The frequency converter circuit comprises at least one radio-frequency (RF) interface being configured to receive at least one RF signal. The frequency converter circuit further comprises an LO input being configured to receive the LO signal. The frequency converter circuit is configured to convert the at least one RF signal into at least one intermediate frequency (IF) signal based on the LO signal. The adaptable frequency of the first clock signal and the adaptable FTW of the first DDS circuit are configured such that the IF signal is free of spurs emitted by the first DDS circuit at least in a predetermined frequency band.

Therein and in the following, the term “based on the LO signal” is understood to denote that the LO signal itself or a signal obtained from the LO signal by signal processing techniques may be used. For example, the LO signal may be processed by a frequency multiplier circuit, a frequency divider circuit, a mixer circuit being configured to convert the LO signal to another frequency, for example to an intermediate frequency or to a harmonic of the LO signal, an amplifier circuit, an attenuator circuit, a filter circuit, or any other type of suitable signal processing circuit. In general, the term “based on a signal” is understood to denote that the signal itself or a processed version of the signal may be used.

The present disclosure is based on the finding that the frequencies of the spurs emitted by the first DDS circuit can be shifted without changing the frequency of the LO signal by adapting both the adaptable frequency of the first clock signal and the adaptable FTW of the first DDS circuit.

In some embodiments, the adaptable frequency of the first clock signal and the adaptable FTW of the first DDS circuit may be adapted concurrently, for example simultaneously. Therein and in the following, the term “concurrently” is understood to denote that the adaptable frequency and the adaptable FTW are adapted at least partially in parallel, but not necessarily exactly at the same time.

As the frequency of the LO signal remains constant, the frequency of the at least one IF signal remains unchanged (at least for a given frequency of the at least one RF signal). Thus, the spurs can be removed from the predetermined frequency band without the need to adapt the frequency of the IF signal.

Accordingly, the adaptable frequency of the first clock signal and the adaptable FTW of the first DDS circuit are configured such that the at least one RF signal is converted to a desired IF frequency band, namely the predetermined frequency band.

As the frequency of the LO signal remains constant, there is no need to interrupt measurements in order to avoid the negative effects of the spurs. Thus, the time necessary for performing measurements is reduced.

The frequencies of the spurs emitted by the first DDS circuit depend on the frequency of the first clock signal. Conversely, the frequencies of the spurs can be 20 adapted to be outside of the predetermined frequency band by adapting the adaptable frequency of the first clock signal.

In some embodiments, it has been recognized the frequencies of the spurs emitted by the first DDS circuit can be shifted by several MHz by adapting the adaptable frequency of the first clock signal.

The frequency of the LO signal depends on the adaptable frequency of the first clock signal and on the adaptable FTW of the first DDS circuit. Accordingly, the frequency of the LO signal can be kept constant even if the adaptable frequency of the first clock signal is changed, namely by adapting the adaptable FTW of the first DDS circuit appropriately.

Summarizing, the measurement circuit according to embodiments of the present disclosure allows for avoiding the negative effects of spurs emitted by the first DDS circuit in an efficient manner, for example when known, band-limited RF signals having a compact support are to be analyzed.

According to an aspect of the present disclosure, the predetermined frequency band is, for example, a desired analysis band used for measurements. Thus, no spurs emitted by the first DDS circuit are present in the frequency band used for measurements. Accordingly, the accuracy of measurement results may be enhanced considerably.

In an embodiment of the present disclosure, the measurement circuit further comprises at least one analog-to-digital converter (ADC), wherein the at least one ADC is connected with the frequency converter circuit so as to receive the at least one IF signal, and wherein the at least one ADC is configured to digitize the at least one IF signal, thereby obtaining at least one digital IF signal. The measurement circuit may further comprise a sampling clock input being connected with the at least one ADC, wherein the sampling clock input is configured to receive a sampling clock signal, and wherein the at least one ADC is configured to digitize the at least one IF signal based on the sampling clock signal. In some embodiments, an ADC is provided for each IF signal.

In some embodiments, a sample rate of the at least one ADC may be set based on the sampling clock signal. For example, the sample rate of the at least one ADC may 20 correspond to a frequency of the sampling clock signal, to a predefined multiple of the frequency of the sampling clock signal, or to a predefined fraction of the frequency of the sampling clock signal.

In some embodiments, the sample rate of the at least one ADC can be set independent of the adaptable frequency of the first clock signal.

In some embodiments, the adaptable frequency of the first clock signal, the adaptable FTW of the first DDS circuit, and/or a frequency of the sampling clock signal may be configured such that the digital IF signal is free of spurs. In some embodiments, the at least one ADC may introduce additional spurs into the digital IF signal, which can be avoided by a suitable choice of the adaptable frequency of the first clock signal, of the adaptable FTW of the first DDS circuit, and of the frequency of the sampling clock signal. Accordingly, both types of spurs, i.e. the spurs emitted by the first DDS circuit and the spurs emitted by the at least one ADC, can be avoided simultaneously by appropriately configuring the adaptable frequency of the first clock signal, the adaptable FTW of the first DDS circuit, and the frequency of the sampling clock signal.

A further aspect of the present disclosure provides that the measurement circuit further comprises, for example, a second signal generator circuit. The second signal generator circuit comprises a second clock generator circuit that is connected to the clock input. The second clock generator circuit is configured to generate a second clock signal having an adaptable frequency based on the reference clock signal. The second signal generator circuit further comprises a second DDS circuit that is connected to the second clock generator circuit. The second DDS circuit is configured to generate an output signal based on the second clock signal and based on an adaptable frequency tuning word (FTW) of the second DDS circuit. The frequency converter circuit is connected with the second DDS circuit so as to receive the output signal of the second DDS circuit.

In general, the output signal of the second DDS circuit may be used as a reference signal for performing measurements, and/or as a test signal that is applied to a device under test. Accordingly, the second DDS circuit may also be called a source oscillator circuit, and the output signal of the second DDS circuit may be a source oscillator signal.

In some embodiments, the adaptable frequency of the first clock signal, the adaptable frequency of the second clock signal, the adaptable FTW of the first DDS circuit, and the adaptable FTW of the second DDS circuit may be configured such that the output signal converted to an intermediate frequency is free of spurs emitted by the first DDS circuit and/or free of spurs emitted by the second DDS circuit at least in the predetermined frequency band.

In some embodiments, the frequency converter circuit may be configured to convert the output signal of the second DDS circuit into at least one intermediate frequency (IF) reference signal based on the LO signal. Therein, the adaptable frequency of the first clock signal, the adaptable FTW of the first DDS circuit, the adaptable frequency of the second clock signal, and/or the adaptable FTW of the second DDS circuit may be configured such that the IF reference signal is free of spurs emitted by the first DDS circuit and/or free of spurs emitted by the second DDS circuit at least in the predetermined frequency band. Accordingly, the output signal of the second DDS circuit may be used to generate a reference signal for performing measurements, wherein the reference signal corresponds to the output signal of the second DDS circuit converted to an intermediate frequency.

In some embodiments, the frequency converter circuit may comprise, for example, a signal distribution circuit that is connected with the second DDS circuit so as to receive the output signal of the second DDS circuit. In some embodiments, the signal distribution circuit may be connected with the RF interface, wherein the signal distribution circuit is configured to forward the output signal of the second DDS circuit to the RF interface. Accordingly, the output signal of the second DDS circuit may be applied to a port of a device under test via the signal distribution circuit and via the RF interface.

For example, the signal distribution circuit may comprise a directional coupler that is configured to forward the output signal of the second DDS circuit to the RF interface. In some embodiments, the directional coupler may be configured to split the output signal of the second DDS circuit, such that the output signal is forwarded to the RF interface and to another component of the frequency converter circuit, for example to a mixer circuit associated with the output signal of the second DDS circuit.

In some embodiments, the signal distribution circuit may be configured to receive the at least one RF signal from the RF port.

In some embodiments, the signal distribution circuit may comprise any suitable type of signal processing circuitry configured to process the at least one RF signal and/or the output signal of the second DDS circuit, e.g., a directional coupler, a bridge, a frequency multiplier circuit, a frequency divider circuit, an amplifier circuit, an attenuator circuit, a filter circuit, a switch, or any combination thereof.

The at least one RF signal may correspond to the output signal of the second DDS circuit, which was reflected at a port of a device under test, or to an output signal of a second DDS circuit of another measurement circuit, which was processed by a device under test.

In some embodiments, the adaptable frequency of the second clock signal and the adaptable FTW of the second DDS circuit are configured such that the IF signal is free of spurs emitted by the second DDS circuit at least in the predetermined frequency band.

In an embodiment of the present disclosure, the first clock generator circuit and the second clock generator circuit are integrated into a common circuit at least partially. For example, the first clock generator circuit and the second clock generator circuit may comprise a common clock input being configured to receive the reference clock signal.

According to an aspect of the present disclosure, the measurement circuit further comprises, for example, a control input configured to receive a control signal.

In some embodiments, the adaptable frequency of the first clock signal and the adaptable FTW of the first DDS circuit are adaptable by the control signal. Thus, the adaptable frequency of the first clock signal and the adaptable FTW of the first DDS circuit can be adapted by providing a corresponding control signal to the control input of the measurement circuit.

Additionally or alternatively, the adaptable frequency of the second clock signal and the adaptable FTW of the second DDS circuit are adaptable by the control signal. Thus, the adaptable frequency of the second clock signal and the adaptable FTW of the second DDS circuit can be adapted by providing a corresponding control signal to the control input of the measurement circuit.

It is emphasized that the adaptable frequency of the second clock signal and the adaptable FTW of the second DDS circuit are adaptable independent of the adaptable frequency of the first clock signal and the adaptable FTW of the first DDS circuit.

The measurement circuit may comprise a splitter circuit downstream of the first DDS circuit and/or a switch upstream of the LO input. The switch may be configured to selectively forward the LO signal generated by the first DDS circuit or an external LO signal to the frequency converter circuit. For example, the external LO signal corresponds to the LO signal of another measurement circuit.

The splitter circuit may be configured to forward the LO signal to the frequency converter circuit and to at least one connection circuit. The connection circuit may be configured to forward the LO signal to another measurement circuit.

In some embodiments, the splitter circuit and the switch may be integrated in a routing circuit, wherein the routing circuit may be controllable to switch between different modes. The different modes may comprise a switch mode, wherein the routing circuit is configured as the switch described above in the switch mode. The different modes may comprise a split mode, wherein the routing circuit is configured as the splitter circuit described above in the split mode. The different modes may comprise a switch and split mode, wherein the routing circuit is configured as a combination of the splitter circuit and of the switch described above in the switch and split mode.

Embodiments of the present disclosure further provide a measurement instrument. In an embodiment, the measurement instrument comprises at least one measurement circuit according to any one of the embodiments described above. In some embodiments, the measurement instrument may comprise two or more measurement circuits according to any one of the embodiments described above.

Regarding the further advantages and properties of the measurement instrument, reference is made to the explanations given above with respect to the measurement circuit, which also hold for the measurement instrument and vice versa.

In an embodiment of the present disclosure, the measurement instrument further comprises a control circuit, wherein the control circuit is configured to generate at least one control signal, and wherein the adaptable frequency of the first clock signal and the adaptable FTW of the first DDS circuit is adaptable by the at least one control signal. For example, the at least one control signal may be forwarded to the first clock generator circuit and to the first DDS circuit of the at least one measurement circuit via a control input of the at least one measurement circuit.

In some embodiments, the adaptable frequency of the second clock signal and the adaptable FTW of the second DDS circuit may be adaptable by the at least one control signal. For example, the at least one control signal may be forwarded to the second clock generator circuit and to the second DDS circuit of the at least one measurement circuit via the control input of the at least one measurement circuit.

The control circuit may be configured to generate the at least one control signal based on an output signal of the at least one measurement circuit. The control circuit may be configured to analyze the output signal of the at least one measurement circuit, thereby obtaining analysis data associated with the output signal. The control circuit may further be configured to generate the control signal based on the analysis data.

In some embodiments, the analysis data may comprise information on spurs emitted by the first DDS circuit (and of the second DDS circuit) that may be comprised in the output signal of the at least one measurement circuit, for example information on frequencies of the spurs. If necessary, the control circuit may generate the at least one control signal for the first clock generator circuit (and for the second clock generator circuit) and for the first DDS circuit (and for the second DDS circuit), such that the adaptable frequency of the first clock signal (and of the second clock signal) and/or the adaptable FTW of the first DDS circuit (and of the second DDS circuit) are adapted to the effect that the spurs are shifted out of the predetermined frequency band.

In some embodiments, the output signal is a digital IF signal. Accordingly, the control circuit may be connected with at least one ADC of the at least one measurement circuit. Thus, the analysis data may comprise information on spurs emitted by the at least one ADC. The control circuit may control the first clock generator circuit and the first DDS circuit as described above, such that the spurs emitted by the at least one ADC are shifted out of the predetermined frequency band.

According to another aspect of the present disclosure, the control circuit comprises, for example, a memory. In an embodiment, the memory comprises different sets of parameters, and wherein the control circuit is configured to generate the at least one control signal based on the different sets of parameters. The sets of parameters may each comprise an output frequency of the first clock generator circuit, an output frequency of the first DDS circuit, and/or an FTW of the first DDS circuit.

For example, the sets of parameters may relate to different target frequencies of the LO signal, wherein each set of parameters may comprise combinations of output frequencies of the first clock generator circuit and FTWs of the first DDS circuit corresponding to the respective target frequency of the LO signal.

In other words, for a given target frequency of the LO signal, the control circuit may select a combination of an output frequency of the first clock generator circuit and an FTW of the first DDS circuit from the sets of parameters for controlling the first clock generator circuit and the first DDS circuit such that the spurs are shifted out of the predetermined frequency band.

In some embodiments, the measurement instrument further comprises a sampling clock generator circuit, wherein the sampling clock generator circuit is configured to generate a sampling clock signal based on the reference clock signal. In some embodiments, a sample rate of the at least one ADC described above may be set based on the sampling clock signal.

In some embodiments, the sample rate of the at least one ADC can be set independent of the adaptable frequency of the first clock signal, and independent of the adaptable frequency of the second clock signal.

In some embodiments, the measurement instrument may further comprise a clock source. The clock source may be configured to generate the reference clock signal. For example, the clock source may comprise a voltage-controlled oscillator that is configured to generate the reference clock signal. However, it is to be understood that any other suitable type of clock source may be used.

In an embodiment of the present disclosure, the measurement instrument comprises at least two measurement circuits, wherein the at least two measurement circuits are interconnected via a connection circuit. The at least two measurement circuits may be established according to any one of the embodiments described above, respectively.

In some embodiments, the at least two measurement circuits may comprise a first measurement circuit and a second measurement circuit. The first measurement circuit may comprise a splitter circuit downstream of the first DDS circuit, wherein the splitter circuit is configured to forward the LO signal to the frequency converter circuit and to the connection circuit. The second measurement circuit may comprise a switch upstream of the LO input, wherein the switch is configured to selectively forward the LO signal generated by the first DDS circuit of the second measurement circuit or the LO signal generated by the first DDS circuit of the first measurement circuit to the frequency converter circuit of the second measurement circuit.

In a further embodiment of the present disclosure, the measurement instrument may be, for example, a signal analyzer, a spectrum analyzer, or a vector network analyzer. However, it is to be understood that the measurement instrument may be established as another type of measurement instrument, e.g. as an oscilloscope.

Embodiments of the present disclosure further provide a vector network analyzer. The vector network analyzer comprises at least two measurement circuits. The at least two measurement circuits comprise a clock input, a frequency converter circuit, a first signal generator circuit, and a second signal generator circuit, respectively. The clock input is configured to receive a reference clock signal. The first signal generator circuit comprises a first clock generator circuit that is connected with the clock input. The first clock generator circuit is configured to generate a first clock signal having an adaptable frequency based on the reference clock signal. The first signal generator circuit further comprises a first direct digital synthesizer (DDS) circuit that is connected with the first clock generator circuit. The first DDS circuit is configured to generate a local oscillator (LO) signal based on the first clock signal and based on an adaptable frequency tuning word (FTW) of the first DDS circuit. The frequency converter circuit comprises at least one radio-frequency (RF) interface being configured to receive at least one RF signal. The frequency converter circuit further comprises an LO input being configured to receive the LO signal. The frequency converter circuit is configured to convert the at least one RF signal into at least one intermediate frequency (IF) signal based on the LO signal. The adaptable frequency of the first clock signal and the adaptable FTW of the first DDS circuit are configured such that the IF signal is free of spurs emitted by the first DDS circuit at least in a predetermined frequency band. The second signal generator circuit comprises a second clock generator circuit that is connected with the clock input. The second clock generator circuit is configured to generate a second clock signal having an adaptable frequency based on the reference clock signal. The second signal generator circuit further comprises a second DDS circuit that is connected with the second clock generator circuit. The second DDS circuit is configured to generate an output signal based on the second clock signal and based on an adaptable frequency tuning word (FTW) of the second DDS circuit. The second DDS circuit is connected to the frequency converter circuit so as to receive the output signal of the second DDS circuit.

Regarding the further advantages and properties of the vector network analyzer, reference is made to the explanations given above with respect to the measurement circuit and with respect to the measurement instrument, which also hold for the vector network analyzer and vice versa.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 schematically shows a first embodiment of a measurement instrument according to the present disclosure;

FIG. 2 schematically shows a second embodiment of a measurement instrument according to the present disclosure;

FIG. 3 schematically shows a frequency converter circuit and a sampling circuit of the measurement instrument of FIG. 2; and

FIG. 4 schematically shows a third embodiment of a measurement instrument according to the present disclosure.

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

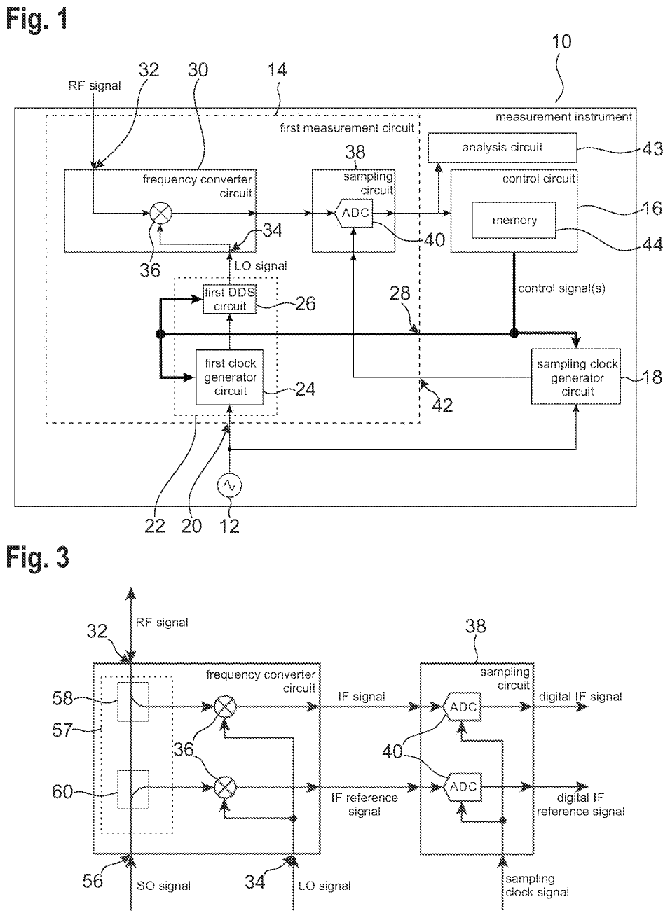

FIG. 1 schematically shows an example of a measurement instrument 10. In general, the measurement instrument 10 is configured to perform measurements on at least one RF signal received from a device under test. In the embodiment shown in FIG. 1, the measurement instrument 10 may be a signal analyzer or a spectrum analyzer. However, it is to be understood that the measurement instrument 10 may be established as another type of measurement instrument, e.g. as an oscilloscope.

In the embodiment of FIG. 1, the measurement instrument 10 comprises a clock source 12, a first measurement circuit 14, a control circuit 16, and a sampling clock generator circuit 18. The clock source 12 is configured to generate a reference clock signal. For example, the clock source 12 may comprise a voltage-controlled oscillator that is configured to generate the reference clock signal. However, it is to be understood that any other suitable type of clock source may be used. Alternatively, the measurement instrument 10 may comprise a reference clock input that is configured to receive the reference clock signal from an external clock source.

Without restriction of generality, the case of the measurement instrument 10 comprising the clock source 12 is described in the following. The clock source 12 is connected with the first measurement circuit 14 and with the sampling clock generator circuit 18, such that the reference clock signal is forwarded to the first measurement circuit 14 and to the sampling clock generator circuit 18. The first measurement circuit 14 comprises a clock input 20 that is configured to receive the reference clock signal.

Downstream of the clock input 20, a first signal generator circuit 22 is provided. The first signal generator circuit 22 comprises a first clock generator circuit 24 and a first direct digital synthesizer (DDS) circuit 26. The first clock generator circuit 24 is configured to generate a first clock signal having an adaptable frequency based on the reference clock signal.

For example, the first clock generator circuit 24 comprises a DDS circuit being configured to generate the first clock signal, a voltage-controlled oscillator being configured to generate the first clock signal, a voltage-controlled oscillator with a phase-locked loop being configured to generate the first clock signal, a frequency multiplier circuit being configured to generate the first clock signal, an up-conversion circuit being configured to generate the first clock signal, and/or a down-conversion circuit being configured to generate the first clock signal.

The first DDS circuit 26 is configured to generate a local oscillator (LO) signal based on the first clock signal and based on an adaptable frequency tuning word (FTW) of the first DDS circuit 26. For example, the adaptable FTW may be stored in a frequency tuning register of the first DDS circuit 26.

In the embodiment of FIG. 1, the first measurement circuit 14 further comprises a control input 28 that is connected to the control circuit 16. The control input 28 is further connected to the first clock generator circuit 24 and to the first DDS circuit 26. The control input 28 is configured to receive at least one control signal from the control circuit 16, and to forward the at least one control signal to the first clock generator circuit 24 and to the first DDS circuit 26.

The first measurement circuit 14 may further comprise, for example, a frequency converter circuit 30. In the embodiment shown, the frequency converter circuit 30 comprises at least one radio-frequency (RF) interface 32 being configured to receive at least one RF signal, as well as an LO input 34 being configured to receive the LO signal from the first DDS circuit 26.

The frequency converter circuit 30 further comprises at least one mixer circuit 36 that is configured to convert the at least one RF signal into at least one intermediate frequency (IF) signal based on the LO signal. More precisely, the at least one mixer circuit 36 is configured to mix the at least one RF signal with the LO signal (or with a signal obtained from the LO signal by suitable signal processing techniques), thereby obtaining the at least one IF signal. In an embodiment, the mixer circuit 36 may comprise a lowpass filter or a bandpass filter that is configured to remove signal portions having a frequency equal to the sum of frequencies of the LO signal and of the at least one RF signal.

The first measurement circuit 14 may further comprise, for example, a sampling circuit 38 with at least one analog-to-digital converter (ADC) 40. The at least one ADC 40 is connected with the frequency converter circuit 30 so as to receive the at least one IF signal.

The first measurement circuit 14 comprise, for example, a sampling clock input 42 that is configured to receive a sampling clock signal, wherein the sampling clock signal is generated by the sampling clock generator circuit 18 based on the reference clock signal. The sampling clock input 42 is configured to forward the sampling clock signal to the at least one ADC 40.

The at least one ADC 40 is configured to digitize the at least one IF signal based on the sampling clock signal, thereby obtaining at least one digitized IF signal. A sample rate of the at least one ADC 40 may be set based on the sampling clock signal. In some embodiments, the sample rate of the at least one ADC 40 may correspond to a frequency of the sampling clock signal, to a predefined multiple of the frequency of the sampling clock signal, or to a predefined fraction of the frequency of the sampling clock signal.

In the embodiment shown, the control circuit 16 is provided downstream of the sampling circuit 38, such that the control circuit 16 receives the at least one digitized IF signal. It is noted that the at least one digitized IF signal may also be forwarded to an analysis circuit 43 of the measurement instrument 10 in order to analyze the at least one digital IF signal.

In general, the control circuit 16 is configured to generate at least one control signal in order to control the sampling clock generator circuit 18, the first clock generator circuit 24, and/or the first DDS circuit 26. In some embodiments, the control circuit 16 may be configured to control the sampling clock generator circuit 18 to adapt a frequency of the sampling clock signal. Further, the control circuit 16 is configured to control the first clock generator circuit 24 to adapt the adaptable frequency of the first clock signal. Moreover, the control circuit 16 is configured to provide a FTW to the first DDS circuit 26, such that the adaptable FTW of the first DDS circuit 26 is updated. Optionally, the control circuit 16 may be configured to control the phase and/or the amplitude of the LO signal generated by the first DDS circuit 26.

In some embodiments, the frequency of the sampling clock signal may be adapted independent of the adaptable frequency of the first clock signal and independent of the adaptable FTW of the first DDS circuit 26. For example, the control circuit 16 is configured to cause the first signal generator circuit 22 to adapt both the adaptable frequency of the first clock signal and the adaptable FTW of the first DDS circuit 26, such that the at least one IF signal is free of spurs emitted by the first DDS circuit 26 at least in a predetermined frequency band.

The adaptable frequency of the first clock signal and the adaptable FTW of the first DDS circuit 26 may be adapted concurrently, for example simultaneously. The predetermined frequency band is a desired analysis band used for measurements performed by the measurement instrument 10 on the at least one RF signal, e.g., for measurements performed by the analysis circuit 43.

In some embodiments, the frequencies of the spurs emitted by the first DDS circuit 26 may be shifted without changing the frequency of the LO signal by (simultaneously) adapting both the adaptable frequency of the first clock signal and the adaptable FTW of the first DDS circuit 26.

As the frequencies of the spurs emitted by the first DDS circuit 26 depend on the frequency of the first clock signal, the frequencies of the spurs can be adapted to be outside of the predetermined frequency band by adapting the adaptable frequency of the first clock signal. Thus, no spurs emitted by the first DDS circuit 26 are present in the frequency band used for measurements performed by the measurement instrument 10, e.g., for measurements performed by the analysis circuit 43.

The at least one ADC 40 may introduce further spurs into the at least one digital IF signal. Accordingly, the control circuit 16 may be configured to cause the first signal generator circuit 22 to (simultaneously) adapt the adaptable frequency of the first clock signal and the adaptable FTW of the first DDS circuit 26, and to cause the sampling clock generator circuit 18 to adapt the frequency of the sampling clock signal, such that the at least one digital IF signal is free of spurs emitted by the at least one ADC 40.

In some embodiments, the control circuit 16 may comprise a memory 44. The memory 44 may comprise different sets of parameters for controlling the first clock generator circuit 24 and/or the first DDS circuit 26. The sets of parameters may each comprise an output frequency of the first clock generator circuit 24, an output frequency of the first DDS circuit 26, and/or an FTW of the first DDS circuit 26.

For example, the sets of parameters may relate to different target frequencies of the LO signal, wherein each set of parameters may comprise combinations of output frequencies of the first clock generator circuit 24 and FTWs of the first DDS circuit 26 corresponding to the respective target frequency of the LO signal. In other words, for a given target frequency of the LO signal, the control circuit 16 may select a combination of an output frequency of the first clock generator circuit 24 and an FTW of the first DDS circuit 26 from the sets of parameters for controlling the first clock generator circuit 24 and/or the first DDS circuit 26 such that the spurs are shifted out of the predetermined frequency band.

Alternatively or additionally, the control circuit 16 may comprise a machine-learning circuit that is pre-trained to generate the control signal(s) based on the at least one digital IF signal received from the sampling circuit 38. The machine-learning circuit may be pre-trained to assess whether a spur comprised in the IF signal influences the measurement result(s).

The machine-learning circuit may, for example, be trained by providing a training data set with two different classes of measurement data to the machine-learning circuit. A first class of measurement data may comprise only data where no spurs are present within the predefined frequency band. A second class of measurement data may comprise data where spurs are present within the predefined frequency band. Any suitable machine-learning technique may be used in order to train the machine-learning circuit.

Accordingly, the digital IF signal corresponds to the input data of the machine-learning circuit. The output of the machine-learning circuit enables a user to distinguish between regions within that set of measurement data where spurs affected measurements and undisturbed regions. If a region was identified where spurs have been detected, the measurement(s) may be repeated with different settings of the first clock generator circuit 24, i.e., with a different frequency of the first clock signal.

The machine-learning circuit may comprise an artificial neural network (ANN) that is pre-trained to generate the control signal(s) based on the at least one digital IF signal received from the sampling circuit 38. The ANN may comprise several neurons set within different layers. Different layers may be set up and trained for specialized tasks. For example, the first layer may be configured to detect irregularities like peaks in the measurement data, even across different measurements within one set of measurement data. A second layer may be configured to analyze the relation of the identified peak to the environment like peak height, prominence, etc.

Alternatively or additionally, the control circuit 16 may be configured to generate the control signal(s) based on the at least one digital IF signal received from the sampling circuit 38 by an algorithm.

In some embodiments, the control circuit 16 may be configured to analyze the at least one digital IF signal, thereby obtaining analysis data associated with the at least one digital IF signal. The control circuit 16 may further be configured to generate the control signal based on the analysis data. In some embodiments, the analysis data may comprise information on spurs emitted by the first DDS circuit 26 (and/or by the at least one ADC 40) that may be comprised in the at least one digital IF signal, for example information on frequencies of the spurs.

If necessary, the control circuit 16 may generate the at least one control signal for the first clock generator circuit 24 and/or for the first DDS circuit 26, such that the adaptable frequency of the first clock signal and/or the adaptable FTW of the first DDS circuit are adapted to the effect that the spurs are shifted out of the predetermined frequency band.

In a certain example, the analysis data may be determined for two different configurations of the first clock generator circuit 24 and/or of the first DDS circuit 26 (i.e. different frequencies of the first clock signal and/or different FTWs of the first DDS circuit 26).

In some embodiments, the control circuit 16 may compare the analysis data associated with the two different settings. If the difference is above a specific threshold, the at least one IF signal is probably disturbed by a spur. If a significant difference is detected, a different configuration of the first clock generator circuit 24 and/or of the first DDS circuit 26 may be used and the analysis data may be determined for the different configuration. Otherwise, the process is terminated.

Alternatively or additionally, the control circuit 16 may be configured to generate the control signal(s) based on settings of the measurement instrument 10. For example, the control circuit 16 may be configured to determine locations (i.e. the frequencies) of the spurs based on the adaptable FTW of the first DDS circuit 26, the adaptable frequency of the first clock signal, the reference clock frequency, settings of the digital signal processing within the first DDS circuit 26 (e.g. truncation of the phase to amplitude converter, and/or divider settings), etc.

Based on the determined locations of the spurs, the control circuit 16 may, if one or several spurs are within the predetermined frequency band, cause the first signal generator circuit 22 to (simultaneously) adapt the adaptable frequency of the first clock signal and the adaptable FTW of the first DDS circuit 26, such that the at least one IF signal is free of spurs emitted by the first DDS circuit 26 at least in the predetermined frequency band.

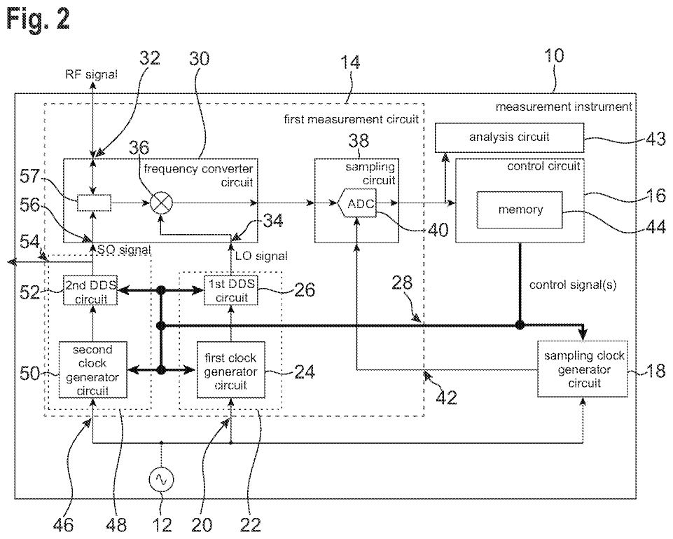

FIG. 2 shows a second embodiment of the measurement instrument 10, wherein only the differences compared to the first embodiment of the measurement instrument 10 described above are explained in the following. In the embodiment shown in FIG. 2, the measurement instrument 10 may be established as a vector network analyzer. The first measurement circuit 14 comprises a further clock input 46, and a second signal generator circuit 48 that is connected with the further clock input 46 so as to receive the clock signal generated by the clock source 12.

In the embodiment shown, the second signal generator circuit 48 comprises a second clock generator circuit 50 and a second DDS circuit 52. The second clock generator circuit 50 is configured to generate a second clock signal having an adaptable frequency based on the reference clock signal. 20

For example, the second clock generator circuit 50 comprises a DDS circuit being configured to generate the second clock signal, a voltage-controlled oscillator being configured to generate the second clock signal, a voltage-controlled oscillator with a phase-locked loop being configured to generate the second clock signal, a frequency multiplier circuit being configured to generate the second clock signal, an up-conversion circuit being configured to generate the second clock signal, and/or a down-conversion circuit being configured to generate the second clock signal.

It is noted that the first clock generator circuit 24 and the second clock generator circuit 50 may be integrated into a common circuit at least partially. For example, the first clock generator circuit 24 and the second clock generator circuit 50 may comprise a common clock input being configured to receive the reference clock signal.

The second DDS circuit 52 is configured to generate an output signal based on the second clock signal and based on an adaptable frequency tuning word (FTW) of the second DDS circuit 52. For example, the adaptable FTW may be stored in a frequency tuning register of the second DDS circuit 52.

In general, the output signal of the second DDS circuit 52 may be used as a reference signal for performing measurements, and/or as a test signal that is applied to a device under test. Accordingly, the second DDS circuit 52 may also be called a source oscillator circuit, and the output signal of the second DDS circuit 52 may be a source oscillator (SO) signal. The output signal of the second DDS circuit 52 may be a sweep signal, i.e. output signal may have a frequency that varies over time in a predetermined manner. Optionally, the second signal generator circuit 48 may comprise a signal output 54, wherein the signal output 54 is connectable with an external device.

In the embodiment shown, the frequency converter circuit 30 comprises an SO signal input 56, wherein the SO signal input 56 is connected with the second DDS circuit 52 so as to receive 20 the output signal of the second DDS circuit 52. Accordingly, the output signal of the second DDS circuit 52 may be used as a reference signal for performing measurements. The frequency converter circuit 30 further comprises a signal distribution circuit 57 that is connected to the RF port 32, the SO signal input 56, and the at least one mixer 36.

FIG. 3 shows the frequency converter circuit 30 and the sampling circuit 38 of the measurement instrument of FIG. 2 in more detail. The frequency converter circuit 30 comprises at least two mixer circuits 36 that each receive the LO signal from the first DDS circuit 26.

The signal distribution circuit 57 comprises a first directional coupler 58 that is configured to forward the at least one RF signal received via the RF port 32 to one of the at least two mixer circuits 36. The signal distribution circuit 57 further comprises a second directional coupler 60 that is configured to forward the output signal of the second DDS circuit 52 to the RF port 32 and to another one of the at least two mixer circuits 36.

The signal distribution circuit 57 may further comprise any suitable type of signal processing circuitry configured to process the at least one RF signal and/or the output signal of the second DDS circuit 52, e.g. a bridge, a frequency multiplier circuit, a frequency divider circuit, an amplifier circuit, an attenuator circuit, a filter circuit, a switch, or any combination thereof.

The at least two mixer circuits 36 are configured to convert the at least one RF signal and the output signal of the second DDS circuit 52 into at least one IF signal and into an IF reference signal based on the LO signal.

The sampling circuit 38 comprises at least two ADCs 40 that each receive the sampling clock signal from the sampling clock generator circuit 18. The at least two ADCs 40 are configured to digitize the at least one IF signal and the IF reference signal, thereby obtaining at least one digital IF signal and a digital IF reference signal.

The at least one IF signal and the IF reference signal are forwarded to the control circuit 16. Moreover, the at least one IF signal and the IF reference signal may be forwarded to the analysis circuit 43 for performing measurements.

The control circuit 16 is configured to generate at least one control signal in order to control the sampling clock generator circuit 18, the first clock generator circuit 24, the first DDS circuit 26, the second clock generator circuit 50, and/or the second DDS circuit 52. In some embodiments, the control circuit 16 is configured to generate at least one control signal based on the at least one IF signal and/or based on the IF reference signal.

Regarding the control signal(s) generated to control the sampling clock generator circuit 18, the first clock generator circuit 24, and the first DDS circuit 26, the explanations given above with respect to FIG. 1 likewise apply.

Further, the control circuit 16 may be configured to control the second clock generator circuit 50 to adapt the adaptable frequency of the second clock signal. Moreover, the control circuit 16 may be configured to provide a FTW to the second DDS circuit 52, such that the adaptable FTW of the second DDS circuit 52 is updated.

In some embodiments, the control circuit 16 may be configured to cause the second signal generator circuit 48 to adapt both the adaptable frequency of the second clock signal and the adaptable FTW of the second DDS circuit 52, such that the output signal of the second DDS circuit 52 has desired properties for testing the device under test, e.g., a desired frequency. Therein, the adaptable frequency of the first clock signal and the adaptable FTW of the second DDS circuit 52 may be adapted concurrently, for example simultaneously.

Moreover, the control circuit 16 may be configured to cause the second signal generator circuit 48 to (simultaneously) adapt the adaptable frequency of the second clock signal and the adaptable FTW of the second DDS circuit 52, such that the IF reference signal and/or the IF signal are free of spurs emitted by the second DDS circuit 52. In some embodiments, the frequency of the sampling clock signal may be adapted independent of the adaptable frequency of the second clock signal and independent of the adaptable FTW of the second DDS circuit 52. Further, the control circuit 16 may be configured to control the phase and/or the amplitude of the output signal generated by the second DDS circuit 52.

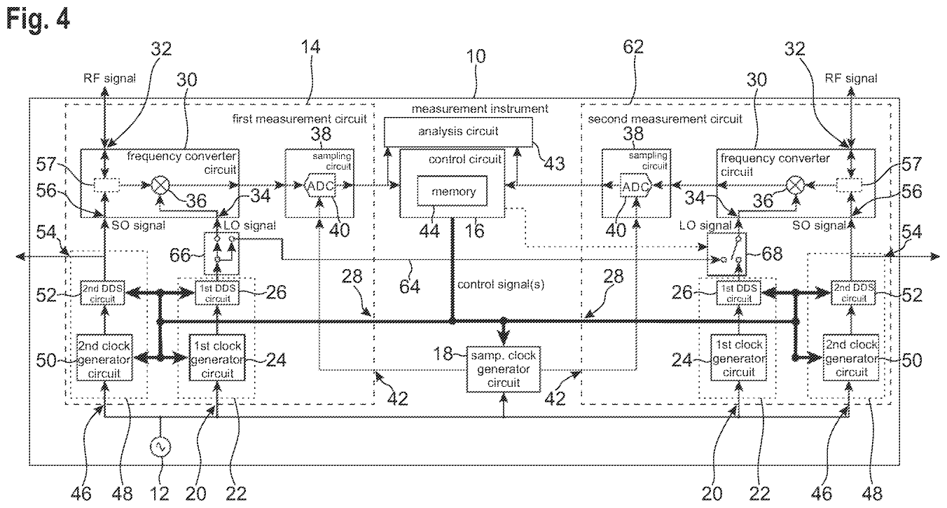

FIG. 4 shows a third embodiment of the measurement instrument 10, wherein only the differences compared to the second variant of the measurement instrument 10 described above are explained in the following.

As shown in FIG. 4, the measurement instrument 10 comprises a second measurement circuit 62, wherein the second measurement circuit 62 is established analogously to the first measurement circuit 14 described above with reference to FIGS. 2 and 3. Accordingly, the explanations given above with respect to the first measurement circuit 14 of FIGS. 2 and 3 likewise apply to the second measurement circuit 62. It is noted that the measurement instrument 10 may comprise an arbitrary number of measurement circuits, i.e., the measurement instrument 10 may comprise more than two measurement circuits.

Thus, the second signal generator circuits 48 of the first measurement circuit 14 and of the second measurement circuit 62 may generate two output signals, wherein the RF ports 32 of the first measurement circuit 14 and of the second measurement circuit 62 may be connected to different ports of the device under test.

Accordingly, the at least one RF signal received via the RF port 32 of the first measurement circuit 14 may correspond to the output signal of the second DDS circuit 52 of the first measurement circuit 14, which was reflected at the corresponding port of the device under test.

Alternatively, the at least one RF signal received via the RF port 32 of the first measurement circuit 14 may correspond to the output signal of the second DDS 20 circuit 52 of the second measurement circuit 62, which was processed by the device under test.

Likewise, the at least one RF signal received via the RF port 32 of the second measurement circuit 62 may correspond to the output signal of the second DDS circuit 52 of the second measurement circuit 62, which was reflected at the corresponding port of the device under test.

Alternatively, the at least one RF signal received via the RF port 32 of the second measurement circuit 62 may correspond to the output signal of the second DDS circuit 52 of the first measurement circuit 14, which was processed by the device under test.

Accordingly, the measurement instrument 10 of FIG. 4 may be established as a vector network analyzer.

Optionally, the measurement instrument 10 further comprises a connection circuit 64.

In the embodiment shown, the first measurement circuit 14 may comprise a splitter circuit 66 downstream of the first DDS circuit 26, wherein the splitter circuit 66 is configured to forward the LO signal to the frequency converter circuit 30 of the first measurement circuit 14 and to the connection circuit 64.

The second measurement circuit 62 may comprise a switch 68 upstream of the LO input 34, wherein the switch 64 is configured to selectively forward the LO signal generated by the first DDS circuit 26 of the first measurement circuit 14 or the LO signal generated by the first DDS circuit 26 of the second measurement circuit 62 to the frequency converter circuit 30 of the second measurement circuit 62. In some embodiments, the switch 68 may be controlled by the control circuit 16 to selectively forward the LO signal generated by the first DDS circuit 26 of the first measurement circuit 14 or the LO signal generated by the first DDS circuit 26 of the second measurement circuit 62 to the frequency converter circuit 30 of the second measurement circuit 62.

It is also conceivable that the measurement circuits 14, 62 each comprise a routing circuit that is connected with the connection circuit 64. The routing circuit may be controllable to switch between different modes, e.g., by the control circuit 16.

In some embodiments, the different modes may comprise a switch mode, wherein the routing circuit is configured as the switch 68 described above in the switch mode. The different modes may comprise a split mode, wherein the routing circuit is configured as the splitter circuit 66 described above in the split mode. The different modes may comprise a switch and split mode, wherein the routing circuit is configured as a combination of the splitter circuit 66 and of the switch 68 described above.

In some embodiments, an arbitrary number of measurement circuits may be interconnected by the connection circuit 64. The measurement circuits can be cascaded in an arbitrary manner by switching the modes of the routing circuits of the individual measurement circuits appropriately.

Certain embodiments disclosed include components that utilize circuitry (e.g., one or more circuits) in order to implement standards, protocols, methodologies or technologies disclosed herein, operably couple two or more components, generate information, process information, analyze information, generate signals, encode/decode signals, convert signals, transmit and/or receive signals, control other devices, etc. Circuitry of any type can be used. It will be appreciated that the term “information” can be use synonymously with the term “signals” in this paragraph. It will be further appreciated that the terms “circuitry,” “circuit,” “one or more circuits,” etc., can be used synonymously herein.

In an embodiment, circuitry includes, among other things, one or more computing devices such as a processor (e.g., a microprocessor), a central processing unit (CPU), a digital signal processor (DSP), an application-specific integrated circuit (ASIC), a field programmable gate array (FPGA), a system on a chip (SoC), or the like, or any combinations thereof, and can include discrete digital or analog circuit elements or electronics, or combinations thereof.

In an embodiment, circuitry includes hardware circuit implementations (e.g., implementations in analog circuitry, implementations in digital circuitry, and the like, and combinations thereof). In an embodiment, circuitry includes combinations of circuits and computer program products having software or firmware instructions stored on one or more computer readable memories that work together to cause a device to perform one or more protocols, methodologies or technologies described herein. In an embodiment, circuitry includes circuits, such as, for example, microprocessors or portions of microprocessor, that require software, firmware, and the like for operation. In an embodiment, circuitry includes an implementation comprising one or more processors or portions thereof and accompanying software, firmware, hardware, and the like.

In some examples, the functionality described herein can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implemented the functionality described herein.

For example, various embodiments of the present disclosure or the functionality thereof may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, computer program instructions, and/or similar terms used herein interchangeably). Such non-transitory computer-readable storage media include all computer-readable media (including volatile and non-volatile media).

Embodiments of the present disclosure may also take the form of an apparatus, system, computing device, computing entity, and/or the like executing instructions stored on computer-readable storage media to perform certain steps or operations. The computer-readable media include cooperating or interconnected computer-readable media, which exist exclusively on a processing or processor system or distributed among multiple interconnected processing or processor systems that may be local to, or remote from, the processing or processor system. However, embodiments of the present disclosure may also take the form of an entirely hardware embodiment performing certain steps or operations.

Various embodiments are described above with reference to block diagrams and/or flowchart illustrations of apparatuses, methods, systems, and/or computer program instructions or program products. It should be understood that each block of any of the block diagrams and/or flowchart illustrations, respectively, or portions thereof, may be implemented in part by computer program instructions, e.g., as logical steps or operations executing on one or more computing devices. These computer program instructions may be loaded onto one or more computer or computing devices, such as special purpose computer(s) or computing device(s) or other programmable data processing apparatus(es) to produce a specifically-configured machine, such that the instructions which execute on one or more computer or computing devices or other programmable data processing apparatus implement the functions specified in the flowchart block or blocks and/or carry out the methods described herein.

These computer program instructions may also be stored in one or more computer-readable memory or portions thereof, such as the computer-readable storage media described above, that can direct one or more computers or computing devices or other programmable data processing apparatus(es) to function in a particular manner, such that the instructions stored in the computer-readable memory produce an article of manufacture including computer-readable instructions for implementing the functionality specified in the flowchart block or blocks.

The computer program instructions may also be loaded onto one or more computers or computing devices or other programmable data processing apparatus(es) to cause a series of operational steps to be performed on the one or more computers or computing devices or other programmable data processing apparatus(es) to produce a computer-implemented process such that the instructions that execute on the one or more computers or computing devices or other programmable data processing apparatus(es) provide operations for implementing the functions specified in the flowchart block or blocks and/or carry out the methods described herein.

It will be appreciated that the term computer or computing device can include, for example, any computing device or processing structure, including but not limited to a processor (e.g., a microprocessor), a central processing unit (CPU), a digital signal processor (DSP), an application-specific integrated circuit (ASIC), a field-programmable gate array (FPGA), a system on a chip (SoC), or the like, or any combinations thereof.

Accordingly, blocks of the block diagrams and/or flowchart illustrations support various combinations for performing the specified functions, combinations of operations for performing the specified functions and program instructions for performing the specified functions. Again, it should also be understood that each block of the block diagrams and flowchart illustrations, and combinations of blocks in the block diagrams and/or flowchart illustrations, or portions thereof, can be implemented by special purpose hardware-based computer systems or circuits, etc., or combinations of special purpose hardware and computer instructions. Each of these special purpose hardware-based computer systems or circuits, etc., or combinations of special purpose hardware circuits and computer instructions form specifically configured circuits, machines, apparatus, devices, etc., capable of implemented the functionality described herein.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Throughout this specification, terms of art may be used. These terms are to take on their ordinary meaning in the art from which they come, unless specifically defined herein or the context of their use would clearly suggest otherwise.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A measurement circuit, comprising
a clock input configured to receive a reference clock signal;
a frequency converter circuit that includes at least one radio-frequency (RF) interface being configured to receive at least one RF signal, and
a first signal generator circuit that includes first clock generator circuit connected with the clock input, wherein the first clock generator circuit is configured to generate a first clock signal having an adaptable frequency based on the reference clock signal, the first signal generator circuit further including a first direct digital synthesizer (DDS) circuit, wherein the first DDS circuit is connected with the first clock generator circuit, wherein the first DDS circuit is configured to generate a local oscillator (LO) signal based on the first clock signal and based on an adaptable frequency tuning word (FTW) of the first DDS circuit,
wherein the frequency converter circuit further comprises an LO input being configured to receive the LO signal,
wherein the frequency converter circuit is configured to convert the at least one RF signal into at least one intermediate frequency (IF) signal based on the LO signal, and
wherein the adaptable frequency of the first clock signal and the adaptable FTW of the first DDS circuit are configured such that the IF signal is free of spurs emitted by the first DDS circuit at least in a predetermined frequency band.

2. The measurement circuit of claim 1, wherein the predetermined frequency band is a desired analysis band used for measurements.

3. The measurement circuit of claim 1, further comprising at least one analog-to-digital converter (ADC), wherein the at least one ADC is connected with the frequency converter circuit so as to receive the at least one IF signal, and wherein the at least one ADC is configured to digitize the at least one IF signal, thereby obtaining at least one digital IF signal, wherein the measurement circuit further comprises a sampling clock input being connected with the at least one ADC,
wherein the sampling clock input is configured to receive a sampling clock signal, and wherein the at least one ADC is configured to digitize the at least one IF signal based on the sampling clock signal.

4. The measurement circuit of claim 3, wherein the adaptable frequency of the first clock signal, the adaptable FTW of the first DDS circuit, and a frequency of the sampling clock signal are configured such that the digital IF signal is free of spurs.

5. The measurement circuit of claim 1, further comprising a second signal generator circuit,
wherein the second signal generator circuit comprises a second clock generator circuit, wherein the second clock generator circuit is connected with the clock input, wherein the second clock generator circuit is configured to generate a second clock signal having an adaptable frequency based on the reference clock signal,
wherein the second signal generator circuit further comprises a second DDS circuit, wherein the second DDS circuit is connected with the second clock generator circuit, wherein the second DDS circuit is configured to generate an output signal based on the second clock signal and based on an adaptable frequency tuning word (FTW) of the second DDS circuit, and
wherein the frequency converter circuit is connected with the second DDS circuit so as to receive the output signal of the second DDS circuit.

6. The measurement circuit of claim 5, wherein the adaptable frequency of the first clock signal, the adaptable frequency of the second clock signal, the adaptable FTW of the first DDS circuit, and the adaptable FTW of the second DDS circuit are configured such that the output signal converted to an intermediate frequency is free of spurs emitted by the first DDS circuit and/or free of spurs emitted by the second DDS circuit at least in the predetermined frequency band.

7. The measurement circuit of claim 5, wherein the at least one RF signal corresponds to the output signal of the second DDS circuit, which was reflected at a port of a device under test, or to an output signal of a second DDS circuit of another measurement circuit, which was processed by a device under test.

8. The measurement circuit of claim 5, wherein the first clock generator circuit and the second clock generator circuit are integrated into a common circuit at least partially.

9. The measurement circuit of claim 1, further comprising a control input, wherein the control input is configured to receive a control signal, and wherein the adaptable frequency of the first clock signal and the adaptable FTW of the first DDS circuit are adaptable by the control signal.

10. The measurement circuit of claim 5, further comprising a control input, wherein the control input is configured to receive a control signal, and wherein the adaptable frequency of the second clock signal and the adaptable FTW of the second DDS circuit are adaptable by the control signal.

11. The measurement circuit of claim 1, wherein the measurement circuit comprises a splitter circuit downstream of the first DDS circuit and/or a switch upstream of the LO input, wherein the switch is configured to selectively forward the LO signal generated by the first DDS circuit or an external LO signal to the frequency converter circuit.

12. A measurement instrument, the measurement instrument comprising at least one measurement circuit according to claim 1.

13. The measurement instrument of claim 12, further comprising a control circuit, wherein the control circuit is configured to generate at least one control signal, and wherein the adaptable frequency of the first clock signal and the adaptable FTW of the first DDS circuit are adaptable by the at least one control signal.

14. The measurement instrument of claim 13, wherein the control circuit is configured to generate the at least one control signal based on an output signal of the at least one measurement circuit.

15. The measurement instrument of claim 14, wherein the output signal is a digital IF signal.

16. The measurement instrument of claim 13, wherein the control circuit comprises a memory, wherein the memory comprises different sets of parameters, and wherein the control circuit is configured to generate the at least one control signal based on the different sets of parameters.

17. The measurement instrument of claim 12, further comprising a sampling clock generator circuit, wherein the sampling clock generator circuit is configured to generate a sampling clock signal based on the reference clock signal.

18. The measurement instrument of claim 12, wherein the measurement instrument comprises at least two measurement circuits, and wherein the at least two measurement circuits are interconnected via a connection circuit.

19. The measurement instrument of claim 12, wherein the measurement instrument is a signal analyzer, a spectrum analyzer, or a vector network analyzer.

20. A vector network analyzer comprising at least two measurement circuits according to claim 6.
